(19) United States
(12) Patent Application Publication
(10) Pub. No.: US 2012/0287817 A1
(43) Pub. Date: Nov. 15, 2012

(54) APPARATUS, METHOD AND COMPUTER PROGRAM PRODUCT FOR REPLICATING SETTINGS INFORMATION

(75) Inventor: Satoru Yamaguchi, Nagoya-shi (JP)

(73) Assignee: BUFFALO INC., Nagoya-shi (JP)

(21) Appl. No.: 13/467,607

(22) Filed: May 9, 2012

(30) Foreign Application Priority Data
May 11, 2011 (JP) 2011-106036

(51) Int. Cl. H04L 12/28

(52) U.S. Cl. 370/254

(57) ABSTRACT

The apparatus, method and computer program product provide obtain settings information on a network connection set in a first network device; a settings information storage unit that stores the obtained settings information; a configuration information acquirer that obtains configuration information including information about the second network device; and a generator that selects at least part of settings information corresponding to the obtained configuration information among the settings information stored in the settings information storage unit, and utilizes the at least part of the settings information to generate replicate information used to replicate the settings information to the second network device so as to provide a network connection for the second network device.

### CROSS-REFERENCE TO RELATED APPLICATION

This application claims priority to Japanese Patent Application No. 2011-106036 filed on May 11, 2011, which is hereby incorporated by reference in its entirety and for all purposes.

### BACKGROUND

1. Technical Field

This disclosure relates to replicating settings information.

2. Related Art

Automatically replicating (moving) settings information from an old terminal to a new terminal has been known to improve the convenience in replacement of the old terminal with the new terminal. For example, according to the disclosure of JP 2007-336109, a source video player (old terminal) converts the settings information recorded in a recording format specific for the model of the source video player into intermediate information. The source video player then notifies a destination video player (new terminal) of the converted intermediate information. The destination video player analyzes the notified intermediate information and makes settings based on the result of the analysis.

In network devices, there is a similar demand to automate replication of the settings information from an old terminal into a new terminal and thereby improve the convenience in replacement of the old terminal with the new terminal. The network devices, however, have a wide variety of different functions corresponding to different models, so that it is difficult to automate replication of the settings information. The functions of the network device include, for example, wired LAN router functions, wireless LAN router functions and wireless LAN access point functions.

Consequently, there is a need to automatically replicate the settings information of a network device into another network device.

### SUMMARY

According to one aspect of the disclosure, there is provided an apparatus configured to replicate a setting for network connection from a first network device to a second network device, comprising: a settings information acquirer configured to obtain settings information on a network connection set in the first network device; a settings information storage unit configured to store the settings information obtained by the settings information acquirer; a configuration information acquirer configured to obtain configuration information including information representing a class of the second network device; and a generator configured to select at least part of the settings information corresponding to the configuration information obtained by the configuration information acquirer from among the settings information stored in the settings information storage unit, and to use the at least part of the settings information to generate replicate information used to replicate the settings information to the second network device.

The apparatus according to this embodiment selects at least part of the settings information corresponding to the class of the second network device among the settings information on network connection set in the first network device, which is stored in the settings information storage unit, and utilizes the selected settings information to generate the replicate information, which is used to replicate the settings information to the second network device. The settings of the second network device are updated with the replicate information. This aspect provides the apparatus that enables the settings information of a network device (first network device) to be automatically replicated to another network device (second network device).

The apparatus may further comprise a replicator configured to access the second network device and update network connection settings in a storage unit of the second network device, with the generated replicate information.

According to this aspect, the replicator accesses the second network device and updates the settings for network connection in the storage unit of the second network device with the replicate information. This aspect provides the apparatus that enables the settings information of a network device (first network device) to be automatically replicated into another network device (second network device).

In the apparatus, the settings information acquirer may obtain settings information on the network connection set in each of a plurality of first network devices.

According to this aspect, the settings information acquirer obtains various settings information on network connection set in each of the first network devices by using the obtained identification information of each of the first network devices. The advantageous effects described above can accordingly be obtained even when the first network device includes the plurality of network devices.

In the apparatus, the configuration information acquirer may obtains configuration information including information representing class of each of a plurality of the second network devices, and the generator selects at least part of settings information corresponding to the obtained configuration information with respect to each of the second network devices among the settings information stored in the settings information storage unit, and utilizes the at least part of the settings information to generate replicate information used to replicate the settings information to each of the second network devices.

According to this aspect, the generator selects at least part of the settings information corresponding to the class of each of the second network devices, among the various settings information stored in the settings information storage unit, and utilizes the selected settings information to generate plural pieces of replicate information, which are used to replicate the settings information to the plurality of second network devices. The advantageous effects described above can accordingly be obtained even when the second network device includes the plurality of network devices.

The apparatus may further comprise an identification information acquirer configured to obtain identification information used to identify the first network device, wherein the settings information acquirer obtains the settings information by utilizing the identification information obtained by the identification information acquirer.

This aspect obtains the settings information from the first network device by using the identification information.

In the apparatus, the identification information acquirer may send a preset packet by multicast or by broadcast and obtains the identification information from a reply packet sent in reply to the preset packet.

According to this aspect, the identification information acquirer obtains the identification information from the reply packet responding to the preset packet.

In the apparatus, the identification information acquirer may employ UPnP (Universal Plug and Play) to obtain the identification information.

According to this aspect, the identification information acquirer employs UPnP to obtain the identification information.

In the apparatus, the identification information acquirer may issue a check command to verify network communication to all IP addresses estimated to exist in an identical segment, in which the apparatus belongs to, and obtains the identification information from a reply to the check command.

According to this aspect, the identification information acquirer obtains the identification information from the reply to the check command, which is used to verify network communication.

In the apparatus, the settings information acquirer may obtain information in a storage unit of the first network device and analyzes the obtained information, so as to obtain the settings information.

According to this aspect, the settings information acquirer obtains the settings information from the information stored in the storage unit of the network device specified by the obtained identification information.

In the apparatus, the settings information storage unit may further store item information correlated to the settings information, wherein the item information is used to identify each item of the settings information, and the settings information acquirer may obtain information used for a service provided by the first network device to enable the setting for network connection, and retrieves the item information from the information obtained by the settings information acquirer, so as to obtain the settings information.

According to this aspect, the settings information acquirer obtains the settings information from the information used for the service provided to outside to enable various settings on network connection by the network device specified by the obtained identification information.

In the apparatus, the configuration information acquirer may obtain the configuration information, based on user-entered information on a preset entry window.

According to this aspect, the apparatus can receive the user's entry of the configuration information.

The apparatus can become one of the first network device, the second network device, another network device and an information processing apparatus.

According to this aspect, any of various apparatuses and devices may be used as one embodiment of the apparatus of the disclosure.

The present disclosure may be implemented by a variety of other aspects and applications, for example, an information processing apparatus, an information processing method, non-transitory computer program product, a network device, a control method of a network device, a system including an information processing apparatus and a network device, computer programs to enable the functions of any of these methods and apparatuses and devices, and non-transitory media in which such computer programs are stored.

### BRIEF DESCRIPTION OF THE DRAWINGS

FIG. 1 illustrates the general configuration of a network system including an information processing apparatus according to one embodiment;

FIG. 2 illustrates the general structure of the information processing apparatus;

FIG. 3A shows one example of the identification information;

FIG. 3B shows one example of the set file information;

FIG. 3C shows one example of the settings information;

FIG. 3D shows one example of the file generation information;

FIG. 4 is a flowchart showing the procedure of replication process;

FIG. 5 is a flowchart showing the procedure of configuration search process;

FIG. 6 illustrates one example of the identification information after the configuration search process (FIG. 5) in the network system shown in FIG. 1;

FIG. 7 is a flowchart showing the procedure of settings information acquisition process;

FIG. 8 illustrates one example of the set file information;

FIG. 9 illustrates one example of the settings information on completion of step S206 in the settings information acquisition process (FIG. 7) in the network system shown in FIG. 1;

FIGS. 10A and 10B show one example of the router set window and the source file;

FIG. 11 illustrates one example of the settings information on completion of step S212 in the settings information acquisition process (FIG. 7) in the network system shown in FIG. 1;

FIG. 12 is a flowchart showing the procedure of replicate information generation process;

FIG. 13 illustrates one example of entry window used at step S302 in the replicate information generation process;

FIG. 14 illustrates one example of the file generation information used at step S304 in the replicate information generation process;

FIG. 15 illustrates the general structure of a network device according to the second embodiment; and

FIG. 16 is a flowchart showing the procedure of replicate information generation process according to the second embodiment.

### DETAILED DESCRIPTION

### A. First Embodiment

(A-1) Device Configuration

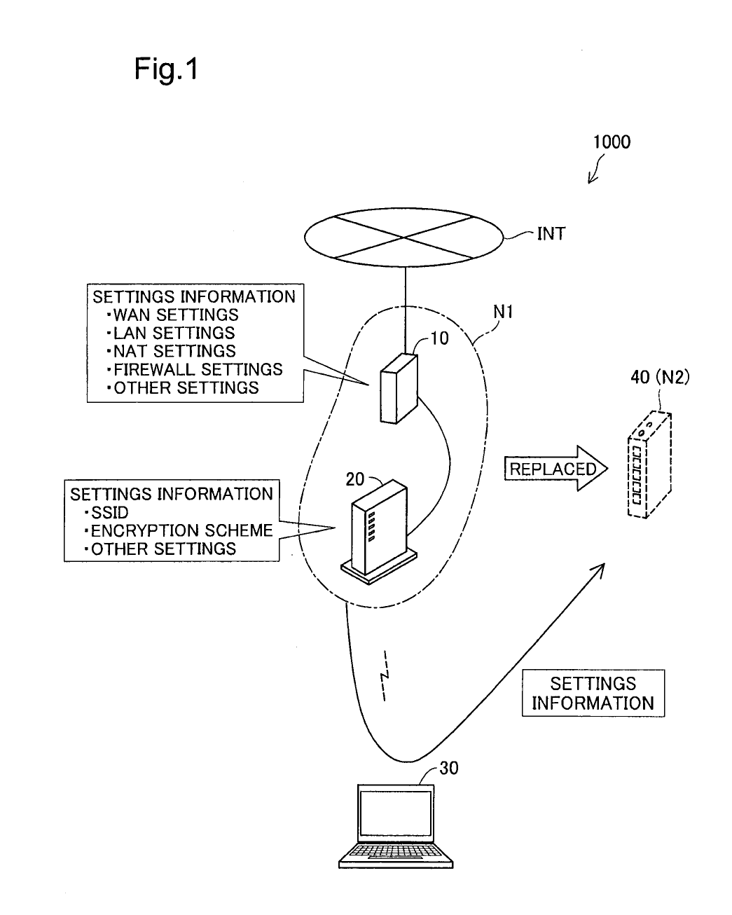

FIG. 1 illustrates the general configuration of a network system 1000 including an information processing apparatus according to one embodiment. The network system 1000 includes a first network device N1 and an information processing apparatus (hereinafter also called “PC”) 30. The first network device N1 includes a plurality of network devices or more specifically a wired router 10 and an access point (hereinafter also called “AP”) 20. For convenience of explanation, other network devices, lines and terminals are omitted from the illustration of FIG. 1. The information processing apparatus 30 may be, for example, a personal computer, a PDA (Personal Digital Assistant), a tablet terminal or a smartphone.

The wired router 10 is a network device that does not conform to the IEEE802.11 standard, i.e., a network device without wireless LAN function. The wired router 10 alone is not capable of establishing a wireless LAN. The wired router 10 is connected to the Internet INT by wire. The access point 20 is a network device that conforms to the IEEE802.11 standard and is capable of establishing a wireless LAN. The access point 20 is connected to the wired router 10 by wire. The information processing apparatus 30 is connected to the access point 20 by wireless.

For proper network connection, the wired router 10, the access point 20 and the information processing apparatus 30 have settings for network connection adequate for the respective functions. More specifically, the wired router 10 has settings for communication with outside (Internet INT) on layer 3 as the network layer of the OSI (Open Systems Interconnection) model. The settings for communication with outside on layer 3 include, for example, WAN settings including a global IP address for communication with outside of the wired router 10 (Internet INT), LAN settings including a private IP address for communication with inside of the wired router 10 (access point 20), NAT (Network Address Translation) settings for mutual conversion between the global IP address and the private IP address, and firewall settings for filtering packets that have passed through the firewall. The access point 20 has settings for wireless LAN communication, for example, SSID (Service Set Identifier) settings for avoiding interference with wireless LAN and settings for encryption scheme (e.g., WEP or WPA) in wireless communication. The contents of these settings for network connection are called “settings information” herein.

In the configuration of FIG. 1, in the case of replacement of the old device (first network device N1 consisting of the wired router 10 and the access point) with a new device (second network device N2 including a wireless router 40), the user is generally required to manually set the second network device N2 by referring to the settings information of the first network device N1. According to this embodiment, however, the information processing apparatus 30 automatically replicates the settings information of the first network device N1 into the second network device N2 according to a replication process described later. The wireless router 40 is a network device conforming to the IEEE802.11 standard and is capable of connecting with the Internet INT by wire and connecting with the information processing apparatus 30 by wireless.

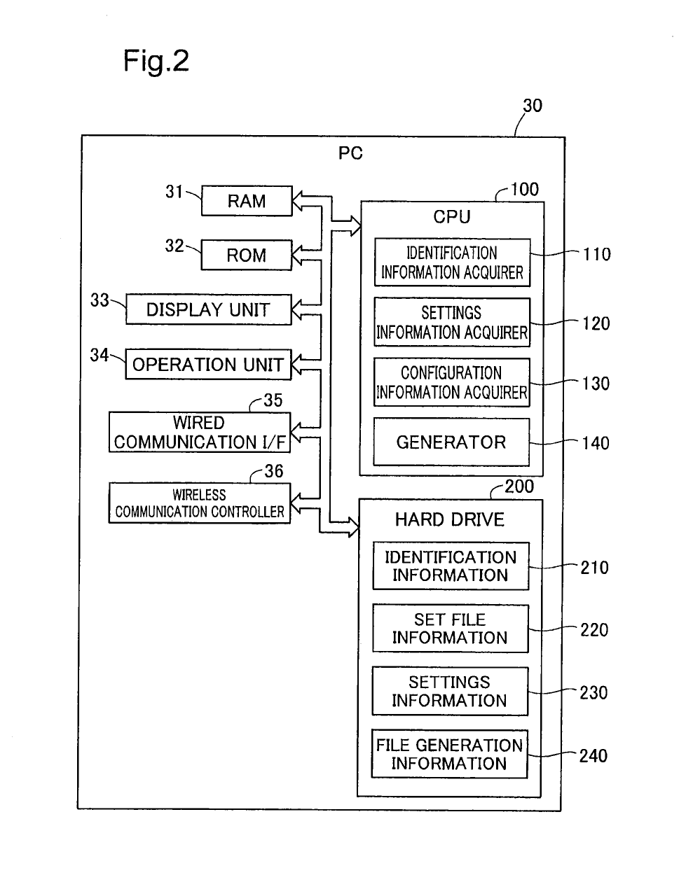

FIG. 2 illustrates the general structure of the information processing apparatus 30. The information processing apparatus 30 includes a RAM 31, a ROM 32, a display unit 22, an operation unit 34, a wired communication interface 35, a wireless communication controller 36, a CPU 100 and a hard drive 200. These components are interconnected by a bus.

The CPU 100 loads and executes a computer program stored in the hard drive 200 on the RAM 31 to control the respective components of the information processing apparatus 30. The CPU 100 also executes a computer program to serve as an identification information acquirer 110, a settings information acquirer 120, a configuration information acquirer 130 and a generator 140. The details of these functional blocks will be described later.

The display unit 33 includes a display and a video controller (not shown) and serves to provide the user with visual screen display. The operation unit 34 includes a mouse and a keyboard (not shown) and their connection interfaces and serves to receive the user's entries. The wired communication interface 35 serves as a connection port of a LAN cable for wired communication. The wires communication controller 36 serves as a control circuit to send and receive signals for wireless communication.

The hard drive 200 serving as the settings information storage unit stores the computer program configured to control the respective components of the information processing apparatus 30 and the computer program configured to implement the respective functions of the identification information acquirer 110, the settings information acquirer 120, the configuration information acquirer 130 and the generator 140. The hard drive 200 also stores identification information 210, set file information 220, settings information 230 and file generation information 240, which are used in the replication process described later.

(A-2) Structures of Various Pieces of Information

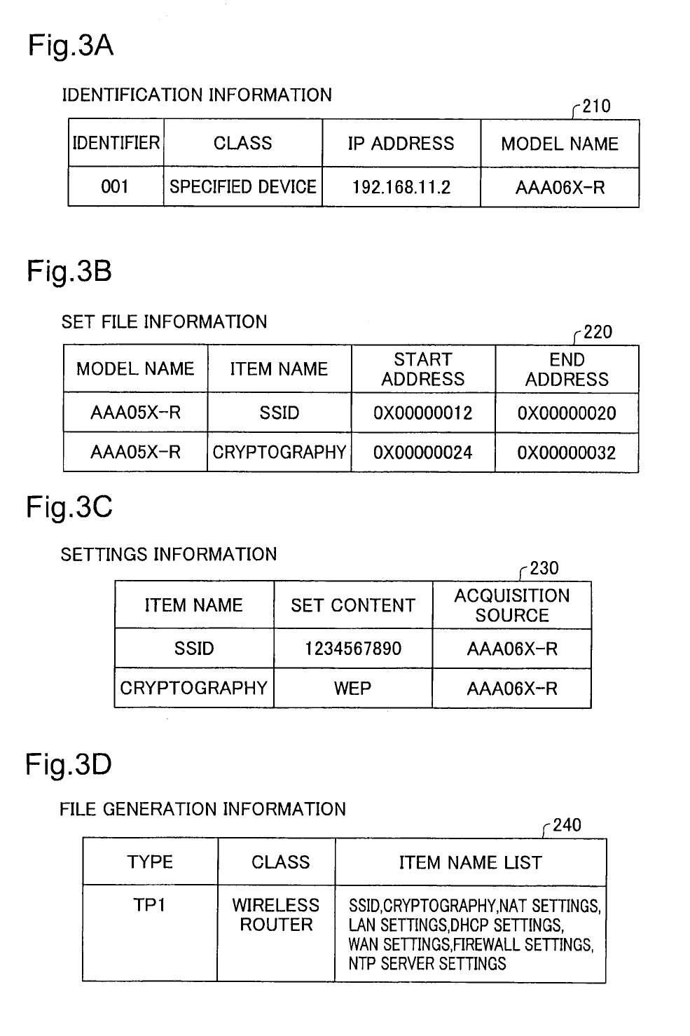

FIGS. 3A to 3D illustrate various pieces of information to be used in the replication process. For convenience of illustration, only part of data is shown in the entry of the respective pieces of information shown in FIGS. 3A to 3D.

FIG. 3A shows one example of the identification information 210. The identification information 210 is generated as a result of a configuration search process as a subroutine of the replication process and is used to store the configuration of the old device (first network device N1).

The identification information 210 includes “identifier”, “class”, “IP address” and “model name”. The “identifier” stores a number for identifying each device included in the first network device N1. The “class” stores information for identifying the class of each device (e.g., specified device, wired router, wireless router, access point) included in the first network device N1. According to this embodiment, the term “specified device” herein refers to a device with the function capable of interpreting a control packet from the information processing apparatus 30 and responding to the control packet. The “IP address” stores an IP address of each device included in the first network device N1. The “model name” stores information representing the model name of each device included in the first network device N1.

FIG. 3B shows one example of the set file information 220. The set file information 220 is used for analysis of binary data in a settings information acquisition process as a subroutine of the replication process. The set file information 220 stores in advance the specification of the locations in binary data where settings information for network connection is stored with respect to a plurality of different models of specified devices.

The set file information 220 includes “model name”, “item name”, “start address” and “end address”. The “model name” stores information representing the model name of the device. The “item name” stores the name for identifying what the settings information is about. The item name is also called “item information”. The “start address” stores a start address of the location where the settings information identified by the item name is stored in the binary data of the device identified by the model name. The “end address” stores an end address of the location where the settings information identified by the item name is stored in the binary data of the device identified by the model name.

FIG. 3C shows one example of the settings information 230. The settings information 230 is generated as a result of the settings information acquisition process as the subroutine of the replication process and is used to store various settings information set in the old device (first network device N1).

The settings information 230 includes “item name (item information)”, “set content”, and “acquisition source”. The “item name” stores the name for identifying what the settings information is about. The “set content” stores the content of the settings information. The “acquisition source” stores the model name of an acquisition source device, from which the settings information is obtained.

FIG. 3D shows one example of the file generation information 240. The file generation information 240 is used to identify configuration information representing the configuration of the new device (second network device N2) during generation of replicate information in a replicate information generation process as a subroutine of the replication process. The file generation information 240 is provided with the contents of the respective entries stored in advance. The term “replicate information” herein means information used to replicate the settings information for the new device (second network device N2).

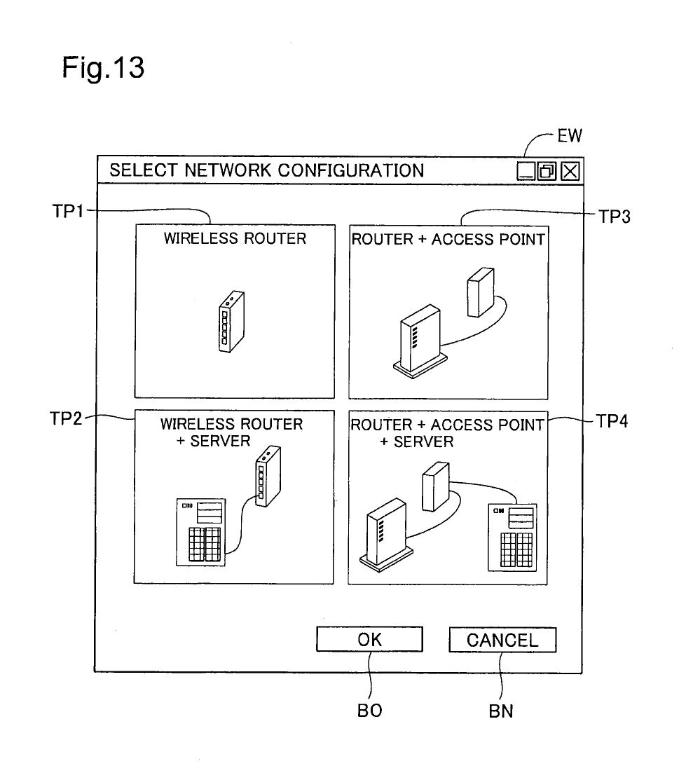

The file generation information 240 includes “type”, “class” and “item name list”. The “type” stores an identifier for specifying the configuration of the second network device N2. The settings of the type correspond to type specification buttons TP1 to TP4 on an entry window (FIG. 13) described later. The “class” stores information for identifying the class of the device (e.g., specified device, wired router, wireless router, access point) included in the second network device N2. The “item name list” stores information indicating what items of settings information are required with respect to the device identified by the class, i.e., information enumerating the required item names (item information). The item name list includes, for example, SSID, cryptography, NAT settings, LAN settings, DHCP (Dynamic Host Configuration Protocol) settings, WAN settings, firewall settings, and NTP (Network Time Protocol) server settings.

(A-3) Replication Process

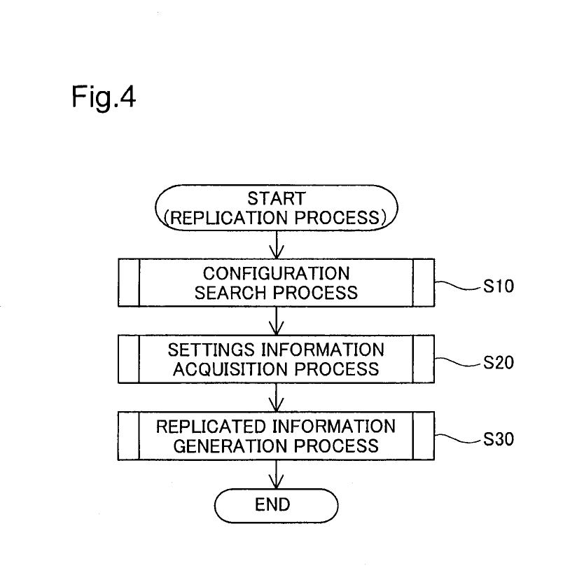

FIG. 4 is a flowchart showing the procedure of replication process. The replication process is triggered by the user's instruction (for example, instruction by selecting a menu option in a menu list displayed via the display unit 33) and is performed by the CPU 100 of the information processing apparatus 30.

The identification information acquirer 110 of the CPU 100 first performs the configuration search process (described later) to obtain the identification information 210 on the first network device N1 (step S10). After acquisition of the identification information 210, the settings information acquirer 120 of the CPU 100 performs the settings information acquisition process (described later) to obtain the settings information 230 on the first network device N1 (step S20). When the first network device N1 consists of a plurality of network devices, the settings information acquirer 120 obtains the settings information 230 with respect to each of the plurality of network devices. After acquisition of the settings information 230, the configuration information acquirer 130 of the CPU 100 performs the replicate information generation process (described later) to obtain configuration information or information on the configuration of the second network device N2. The generator 140 generates the replicate information based on the obtained configuration information and the obtained settings information 230 in this replicate information generation process (step S30). When the second network device N2 consists of a plurality of network devices, the generator 140 generates the replicate information with respect to each of the plurality of network devices.

(A-3-1) Configuration Search Process

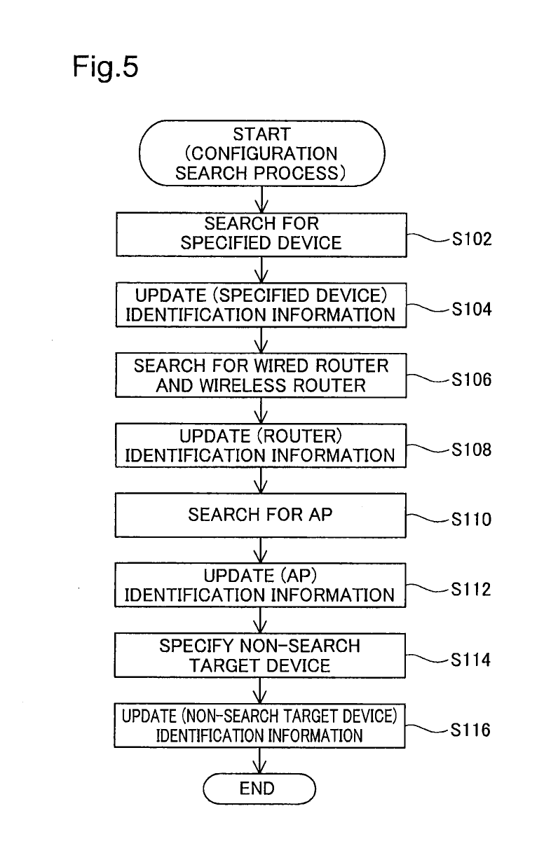

FIG. 5 is a flowchart showing the procedure of configuration search process. The identification information acquirer 110 searches for any specified device (step S102). More specifically, the identification information acquirer 110 sends a preset control packet by broadcast or by multicast and monitors reception of any reply packet for a predetermined time period. When the first network device N1 connecting with the information processing apparatus 30 includes any specified device, the specified device sends a reply packet including the own IP address and the model name as a response to the received control packet. When receiving the reply packet within the predetermined time period, the identification information acquirer 110 determines that the first network device N1 includes the specified device and updates the identification information 210 with the information included in the reply packet (IP address and model name) (step S104). In this update operation, the identification information acquirer 110 sets “specified device” in the class field of the identification information 210.

The identification information acquirer 110 employs UPnP (Universal Plug and Play), which enables any devices connecting with the Internet Protocol (IP) network to recognize each other, to search for any wired router and any wireless router (step S106). More specifically, the identification information acquirer 110 utilizes SSDP (Simple Service Discover Protocol) of UPnP to search for any UPnP-compatible device by multicast. The identification information acquirer 110 subsequently obtains a control URL used to collect additional information on the device from device description obtained as a response to the multicast. The identification information acquirer 110 then sends a preset command to the obtained control URL and obtains an IP address of the wired router (or the wireless router) from a response to the preset command. The identification information acquirer 110 updates the identification information 210 with the obtained IP address (step S108). In this update operation, the identification information acquirer 110 sets “router” in the class field of the identification information 210, while setting vacancy or “unknown” in the model name field of the identification information 210.

The identification information acquirer 110 utilizes lease information of DHCP (Dynamic Host Configuration Protocol), which is used to automatically allocate IP addresses, to search for any access point (step S110). More specifically, the identification information acquirer 110 first connects with the specified device found at step S102 or with the router found at step S106 and obtains a lease file of DHCP. The identification information acquirer 110 subsequently analyzes the obtained lease file with, for example, a MAC address or a host name used as the key, so as to estimate lease information on the access point. The identification information acquirer 110 obtains an IP address of the access point from the estimated lease information and updates the identification information 210 with the obtained IP address (step S112). In this update operation, the identification information acquirer 110 sets “AP” in the class field of the identification information 210, while setting vacancy or “unknown” in the model name field of the identification information 210.

The identification information acquirer 110 specifies any device that is not searched at any of steps S102, S106 and S110 (non-search target device) (step S114). More specifically, the identification information acquirer 110 first issues “ping” or a check command to verify network communication to all IP addresses estimated to exist in the same segment as the segment which the information processing apparatus 30 belongs to. When the IP address/subnet mask of the information processing apparatus 30 is 192.168.1.0/24, “all IP addresses estimated to exist in the same segment as the segment which the information processing apparatus 30 belongs to” cover 192.168.1.1 to 192.168.1.254.

The identification information acquirer 110 obtains an IP address from a reply to the “ping” with respect to the device having the IP address that is not stored in the identification information 210, i.e., the non-search target device that is not searched at any of steps S102, S106 and S110. The identification information acquirer 110 updates the identification information 210 with the obtained IP address (step S116). In this update operation, the identification information acquirer 110 sets “non-search target device” in the class field of the identification information 210, while setting vacancy or “unknown” in the model name field of the identification information 210.

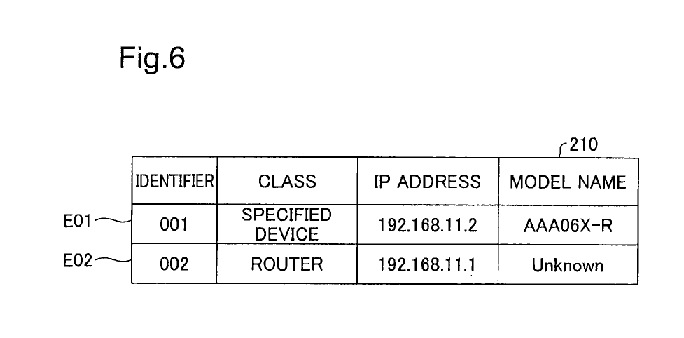

FIG. 6 illustrates one example of the identification information 210 after the configuration search process (FIG. 5) in the network system 1000 shown in FIG. 1. An entry E01 stores information on the access point 20 searched as the specified device, and an entry E02 stores information on the wired router 10 searched as the router.

As described above, in the configuration search process, the identification information acquirer 110 obtains the configuration of the old device (first network device N1) by combining the plurality of means, such as the reply packet responding to the preset packet, UPnP, lease information of DHCP, and the reply packet to the check command (ping) to verify network communication. This process improves the accuracy of the identification information 210 storing the configuration of the first network device N1.

(A-3-2) Settings Information Acquisition Process

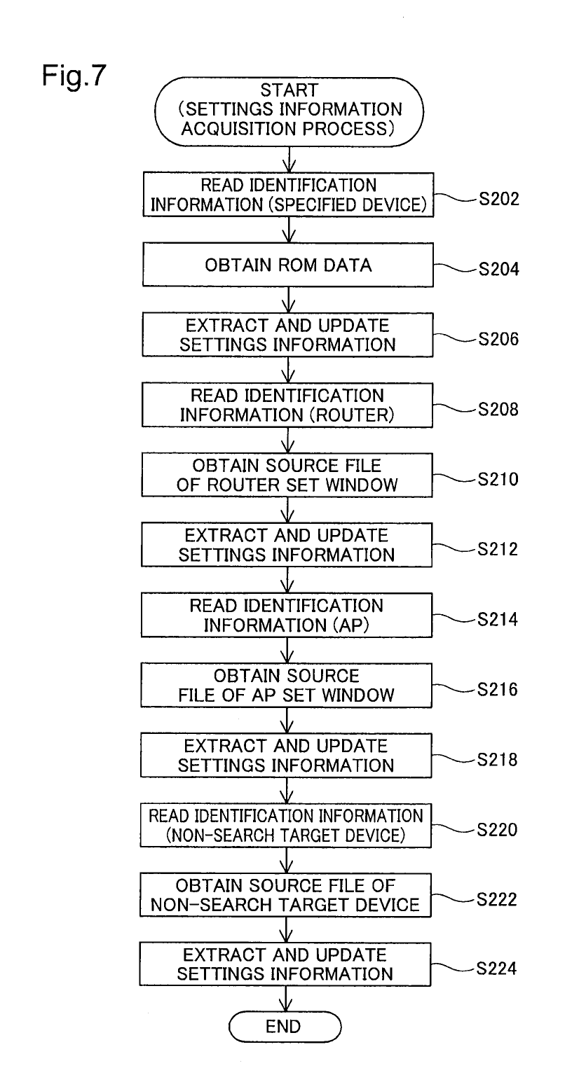

FIG. 7 is a flowchart showing the procedure of settings information acquisition process. The settings information acquirer 120 retrieves any entry with “specified device” set in the class field from the updated identification information 210 and reads the IP address and the model name of the matching entry (step S202). The settings information acquirer 120 then connects with a device having the IP address read at step S202 to obtain data (binary data) stored in the ROM of the device (step S204).

The settings information acquirer 120 extracts settings information from the obtained binary data and updates the settings information 230 (step S206). More specifically, the settings information acquirer 120 retrieves the set file information 220 with the model name read at step S202 as the key. The settings information acquirer 120 then analyzes the obtained binary data based on the item name, the start address and the end address of the read model name stored in the set file information 220 and extracts the settings information from the binary data.

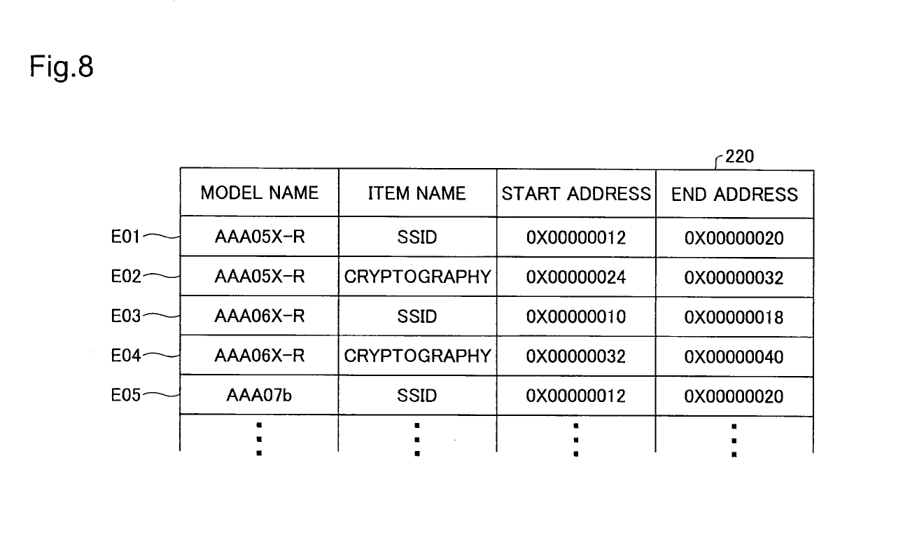

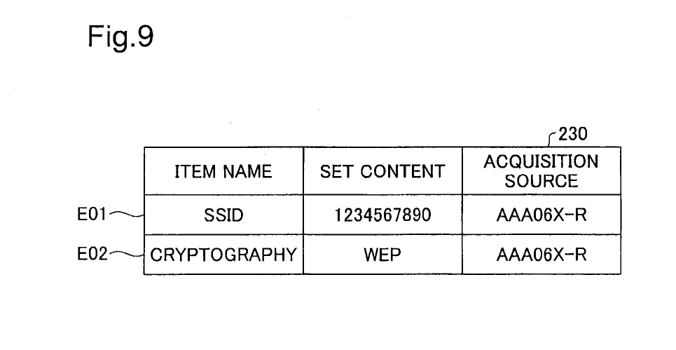

FIG. 8 illustrates one example of the set file information 220. FIG. 9 illustrates one example of the settings information 230 on completion of step S206 in the settings information acquisition process (FIG. 7) in the network system 1000 shown in FIG. 1. A concrete example is described below with reference to FIGS. 8, 9 and 6 (illustrating the identification information 210 after the configuration search process in the network system 1000).

At step S202 in the settings information acquisition process (FIG. 7), the settings information acquirer 120 retrieves the entry E01 with “specified device” set in the class field from the identification information 210 (FIG. 6) and obtains IP address (192.168.11.2) and model name (AAA06X-R). At step S204, the settings information acquirer 120 uses the IP address (192.168.11.2) to connect with the access point 20 and obtains binary data stored in the ROM of the access point 20.

At step S206, the settings information acquirer 120 retrieves the set file information 220 with the model name (AAA06X-R) as the key and obtains item names (SSID and cryptography), start addresses (0x00000010 and 0x00000032) and end addresses (0x00000018 and 0x00000040) stored in matching entries E03 and E04. The settings information acquirer 120 then extracts data stored at the start address 0x00000010 and the end address 0x00000018 as SSID from the obtained binary data and updates the settings information 230 (entry E01 shown in FIG. 9). Similarly the settings information acquirer 120 extracts data stored at the start address 0x00000032 and the end address 0x00000040 as cryptography from the obtained binary data and updates the settings information 230 (entry E02 shown in FIG. 9).

Referring back to FIG. 7, at step S208, the settings information acquirer 120 retrieves any entry with “router” set in the class field from the identification information 120 and reads the IP address and the model name of the matching entry. The settings information acquirer 120 employs http (Hypertext Transfer Protocol), which is the protocol used for data transmission between a WEB server and a client (e.g., Web browser), to connect with the device having the IP address read at step S208 and obtains a source file of a router set window (step S210). The router set window means the service provided by the router to outside to enable registration and change of the settings information.

The settings information acquirer 120 extracts settings information from the obtained source file and updates the settings information 230 (step S212). More specifically, the settings information acquirer 120 sequentially retrieves character strings included in the obtained source file with the generic name representing the router's settings information (e.g., item name of the settings information 230, such as “IP address” or “subnet mask”) as the key and extracts data in a tag including the matching character string as the settings information. For example, the “generic name (item name)” used for such retrieval may be stored in advance in the form of a list in the hard drive 200 of the information processing apparatus 30. In another example, the settings information 230 may be provided to have the storage set in the item name field, and the setting in the item name field may be used for retrieval.

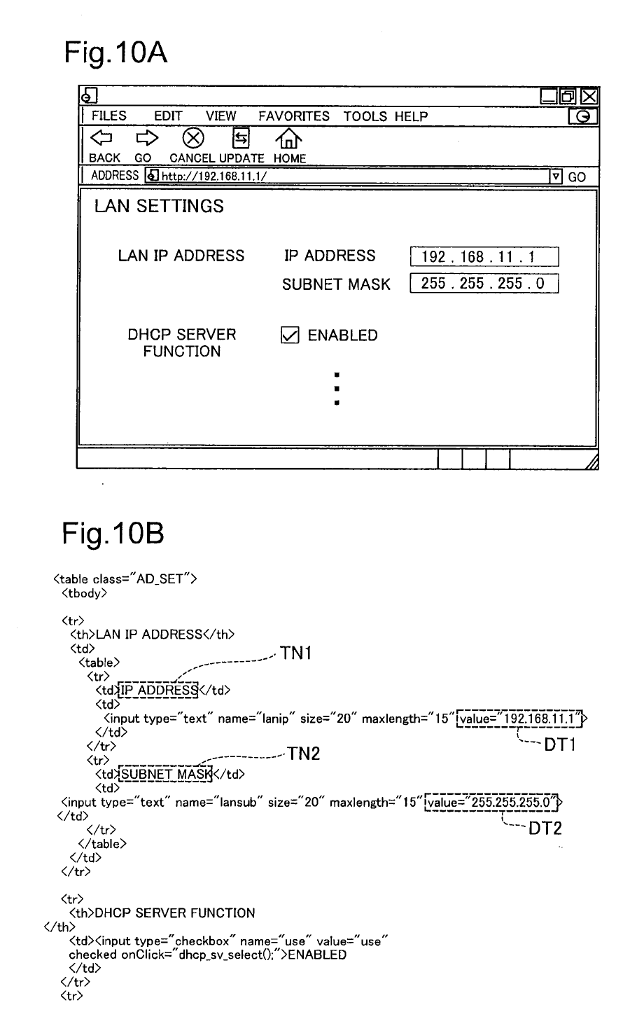

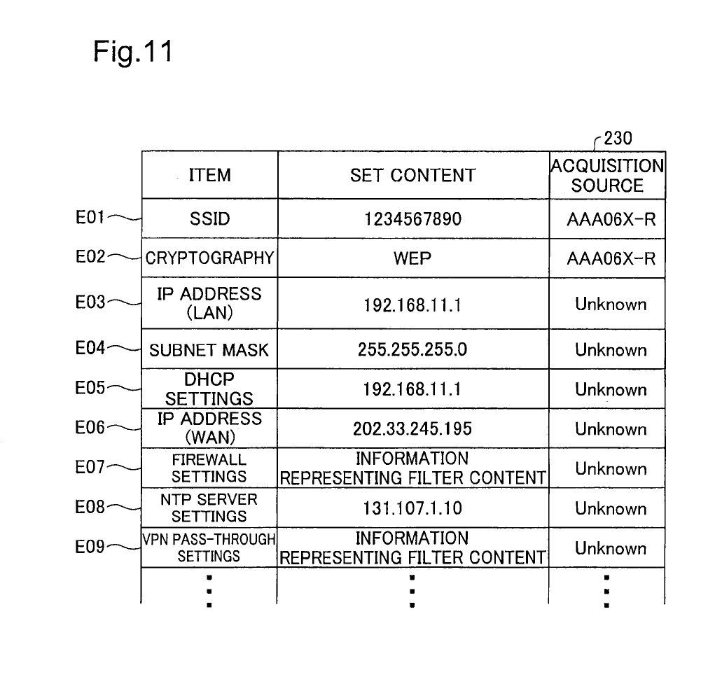

FIGS. 10A and 10B show one example of the router set window and the source file. More specifically, FIG. 10A illustrate one example of the router set window, and FIG. 10B illustrates one example of the source file to display the router set window shown in FIG. 10A. FIG. 11 illustrates one example of the settings information 230 on completion of step S212 in the settings information acquisition process (FIG. 7) in the network system 1000 shown in FIG. 1. A concrete example is described below with reference to FIGS. 10, 11 and 6 (illustrating the identification information 210 after the configuration search process in the network system 1000).

At step S208 in the settings information acquisition process (FIG. 7), the settings information acquirer 120 retrieves the entry E02 with “router” set in the class field from the identification information 210 (FIG. 6) and obtains IP address (192.168.11.1) and model name (unknown). At step S210, the settings information acquirer 120 employs http with specifying URL as http://192.168.11.1 to connect with the wired router 10 having the IP address (192.168.11.1) and obtains a source file of the router set window from the connected wired router 10 (FIG. 10B).

At step S212, the settings information acquirer 120 retrieves the character strings included in the obtained source file with the “IP address” as the key, extracts data in a tag including a matching character string TN1, i.e., “192.168.11.1” stored in value DT1, as the settings information representing the IP address and stores the extracted data into the settings information 230 (entry E03 shown in FIG. 11). Similarly, the settings information acquirer 120 retrieves the character strings included in the obtained source file with the “subnet mask” as the key, extracts data in a tag including a matching character string TN2, i.e., “255.255.255.0” stored in value DT2, as the settings information representing the subnet mask and stores the extracted data into the settings information 230 (entry E04 shown in FIG. 11). The settings information acquirer 120 repeats such retrieval and extraction with respect to the other generic names representing the settings information of the router to update the settings information 230.

Referring back to FIG. 7, at step S214, the settings information acquirer 120 retrieves any entry with “AP” set in the class field from the identification information 210 and reads the IP address and the model name of the matching entry. The settings information acquirer 120 employs http to connect with the device having the IP address read at step S214 and obtains a source file of an access point set window (step S216). The details of this step are identical with those of step S210 described above. The settings information acquirer 120 extracts settings information from the obtained source file and updates the settings information 230 (step S218). The details of this step are identical with those of step S212 described above.

At step S220 in FIG. 7, the settings information acquirer 120 retrieves any entry with “non-search target device” set in the class field from the identification information 210 and reads the IP address and the model name of the matching entry. The settings information acquirer 120 employs http to connect with the device having the IP address read at step S220 and obtains a source file of a non-search target device set window (step S222). The details of this step are identical with those of step S210 described above. The settings information acquirer 120 extracts settings information from the obtained source file and updates the settings information 230 (step S224). The details of this step are identical with those of step S212 described above.

According to another embodiment, only part of the steps included in the settings information acquisition process of FIG. 7 may be performed. For example, the series of processing with respect to the device class that is not included in the class field of the identification information 210 may be omitted from the settings information acquisition process.

As described above, in the settings information acquisition process, the settings information acquirer 120 obtains various pieces of settings information (settings information 230) from the information (binary data) stored in the storage unit (ROM) of the network device specified by the obtained identification information 210 (specified device), as well as the information (source files) used in various services (router set window, access point set window and device set window) provided by the network devices specified by the obtained identification information 210 (router, access point and non-search target device) to outside to enable various settings for network connection. This process enables the settings information on the first network device N1 to be obtained by various methods.

(A-3-3) Replicate Information Generation Process

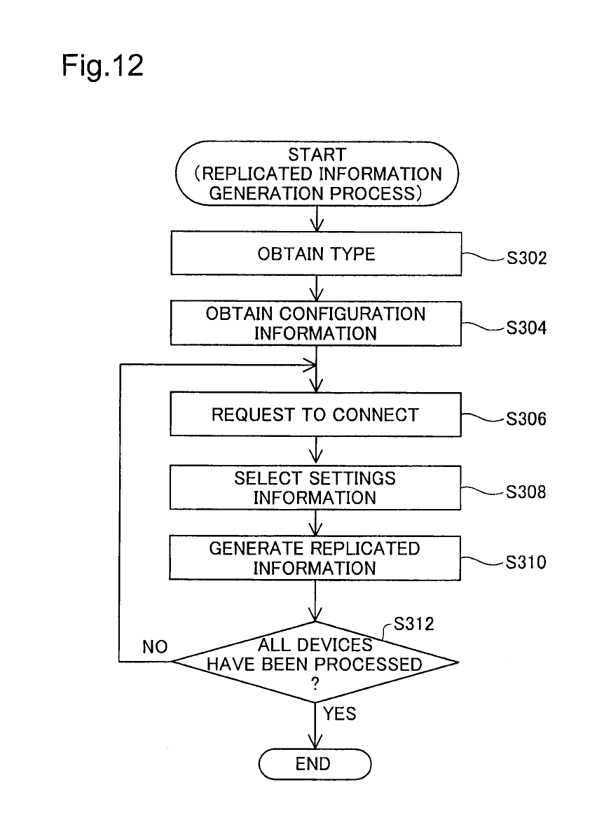

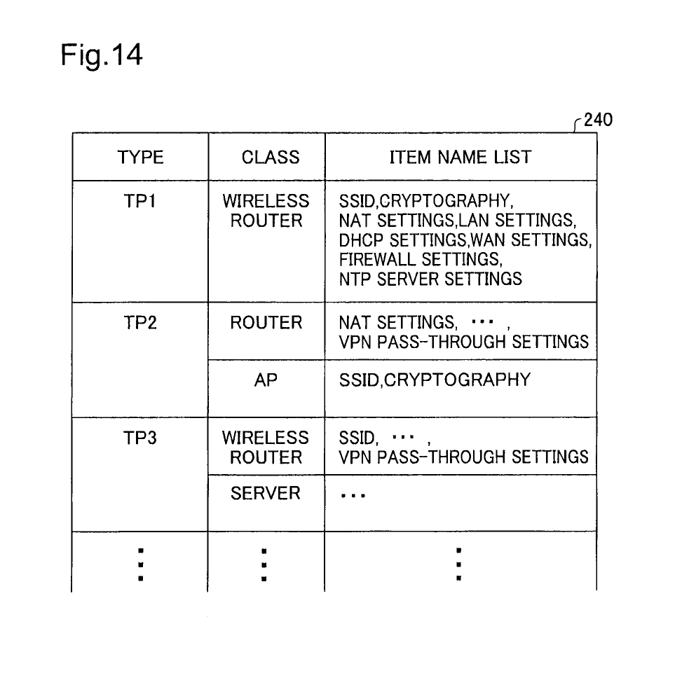

FIG. 12 is a flowchart showing the procedure of replicate information generation process. FIG. 13 illustrates one example of entry window used at step S302 in the replicate information generation process. FIG. 14 illustrates one example of the file generation information 240 used at step S304 in the replicate information generation process.

Referring to FIG. 12, the configuration information acquirer 130 obtains the type of the new device (second network device N2) (step S302). More specifically, the configuration information acquirer 130 opens an entry window on the display unit 33 of the information processing apparatus 30 to receive the user's entry for specifying the device type.

An entry window EW shown in FIG. 13 includes four type select buttons TP1 to TP4, an OK button BO and a cancel button BN. Each of the type select buttons TP1 to TP4 has a character string representing the device configuration of the second network device N2 and a visual representation of the device configuration. One of the character string and the visual representation may be omitted as appropriate. The user selects one configuration identical with or closest to the configuration of the second network device N2 among the four device configurations shown by the type select buttons TP1 to TP4 and presses the button corresponding to the selected configuration. The user subsequently presses the OK button BO. In response to the user's press of the OK button BO, the configuration information acquirer 130 obtains the type (one of TP1 to TP4) specified on the entry window EW.

Referring back to FIG. 12, the configuration information acquirer 130 obtains the configuration information of the second network device N2 (step S304). More specifically, the configuration information acquirer 130 retrieves the file generation information 240 (FIG. 14) with the type (one of TP1 to TP4) specified on the entry window EW as the key and obtains the class and the item name list of any matching entry as the configuration information. When one type includes a plurality of devices, such as the types TP2 to TP4 of the file generation information 240 (FIG. 14), the configuration information acquirer 130 obtains the class and the item name list with respect to each of the plurality of devices.

The generator 140 requests the user to connect the information processing apparatus 30 with a first device of the second network device N2 by wired (step S306). Such a request may be made, for example, by giving a guidance display on the display unit 33 of the information processing apparatus 30. The generator 140 detects the wired connection and subsequently detects the IP address and the class of the wired connected device. The class of the wired connected device may be detected by the same method as described above with respect to steps S102, S106 and S110 in the configuration search process (FIG. 5).

The generator 140 selects at least part of the settings information corresponding to the detected class from the settings information 230 (step S308). More specifically, the generator 140 successively retrieves the settings information 230 (FIG. 11) with each of the items included in the item name list with respect to the device of the class detected at step S306 among the configuration information obtained at step S304, as the key. The generator 140 temporarily stores the settings in the set content field and the item name of any matching entry. The generator 140 then generates the replicate information, based on the settings information selected at step S308 (step S310). More specifically, the replicate information is generated according to the procedure i) or the procedure ii) given below.

i) when the class of the wired connected device is detected as specified device at step S306:

The generator 140 obtains the data (binary data) stored in the ROM of the wired connected device detected at step S306 by the same method as that of step S204 in the settings information acquisition process (FIG. 7). The generator 140 subsequently analyzes the obtained binary data by the same method as that of step S206 in the settings information acquisition process (FIG. 7) and overwrites the corresponding part of the binary data with the settings information temporarily stored at step S308. When the wired connected device included in the second network device N2 is the specified device, the generator 140 generates the replicate information in the form of binary data that is directly writable into the ROM.

The replicate information generated by the procedure i) may be used to update the second network device N2 by various methods. For example, the generator 140 may access the wired connected device of the second network device N2 and update the data (binary data) stored in the ROM of the wired connected device with the replicate information (binary data). In this application, the generator 140 serves as the “replicator” in the claims. In another example, the generator 140 may store the generated replicate information at any arbitrary location in the information processing apparatus 30 (e.g., specified location in the hard drive 200). In another example, the generator 140 may send the generated replicate information to the wired connected device of the second network device N2. In this application, the wired connected device receives the replicate information and updates the own data.

ii) when the class of the wired connected device is detected as non-specified device at step S306:

The generator 140 first obtains the source file of the device set window of the wired connected device detected at step S306 by the same method as that of step S210 in the settings information acquisition process (FIG. 7). The generator 140 then retrieves the obtained source file by the same method as that of step S212 in the settings information acquisition process (FIG. 7) and overwrites data in the corresponding tag of the source file with the settings information temporarily stored at step S308. When the wired connected device included in the second network device N2 is the non-specified device, the generator 140 generates the replicate information in the form of the device set window (or its source file).

The replicate information generated by the procedure may be used to update the second network device N2 by various methods. For example, the generator 140 may display the device set window after overwriting the source file on the display unit 33 of the information processing apparatus 30 to ask for the user's verification and transmission operation. The user may verify the displayed device set window (i.e., the device set window with the set contents selected from the settings information 230 displayed as preset values in specific frames for respective item names) and perform a predetermined transmission operation, such as pressing a Submit button. The set contents of the device set window are then sent to the wired connected device of the second network device N2 to overwrite the settings information stored in the wired connected device. In this application, the generator 140 serves as the “replicator” in the claims. In another example, the generator 140 may store the generated replicate information at any arbitrary location in the information processing apparatus 30 (e.g., specified location in the hard drive 200).

Referring back to FIG. 12, the generator 140 checks whether all the devices included in the configuration information obtained at step S304 have been processed (step S312). When all the devices have been processed, the generator 140 terminates the series of processing. When there is any device to be processed, on the other hand, the generator 140 returns the processing flow to step S306 and repeats the series of processing to generate replicate information with respect to the device to be processed.

As described above, according to the first embodiment, the generator 140 of the information processing apparatus 30 selects at least part of the settings information corresponding to the configuration information, which includes the information representing the class of the second network device N2, from the various settings information 230 on the network connection set in the first network device N1, which is stored in the settings information storage unit (hard drive 200). The generator 140 utilizes the selected settings information to generate the replicate information, which is used to replicate the settings information into the second network device N2. The settings information of the second network device N2 is then updated with the replicate information. Accordingly, the first embodiment provides the information processing apparatus that enables automatic replication of the settings information of the old network device (first network device N1) into the new network device (second network device N2).

Additionally, the generator 140 of the information processing apparatus 30 serves as the replicator to access another network device (second network device N2) and update the settings for network connection in the storage unit of the second network device N2 with the generated replicate information. This improves the convenience of the information processing apparatus.

The first network device N1 may include a plurality of network devices. In this case, the identification information acquirer 110 obtains the identification information (e.g., IP address) of each of the plurality of network devices in the configuration search process. The settings information acquirer 120 uses the obtained identification information 210 of each of the plurality of network devices and obtains the various settings information on network connection set in each of the plurality of network devices in the settings information acquisition process. The advantageous effects of the embodiment described above can accordingly be obtained even when the first network device N1 includes the plurality of network devices.

The second network device N2 may also include a plurality of network devices. In this case, in the replicate information generation process, the generator 140 selects at least part of the settings information corresponding to the class of each of the plurality of network devices from the various settings information 230 stored in the settings information storage unit (hard drive 200) and utilizes the selected settings information to generate the replicate information, which is used to replicate the settings information into each of the plurality of network devices. The advantageous effects of the embodiment described above can accordingly be obtained even when the second network device N2 includes the plurality of network devices.

### B. Second Embodiment

According to a second embodiment of the disclosure, a network device corresponding to the second network device N2 of the first embodiment is capable of performing the replication process. The network device of the second embodiment has substantially the similar functions to those of the information processing apparatus 30 of the first embodiment. Only the differences in configuration and operation from those of the first embodiment are described below. The like components to those of the first embodiment described above are expressed by the like symbols and are not specifically described here.

(B-1) Device Configuration

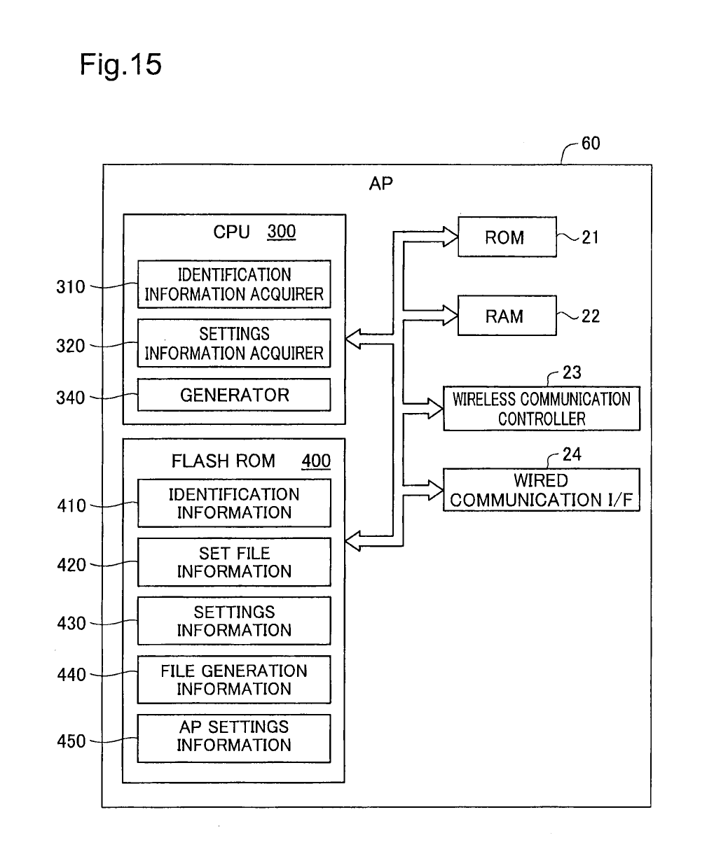

FIG. 15 illustrates the general structure of a network device according to the second embodiment. An access point (AP) 60 is employed as the network device of this embodiment. The access point 60 includes a ROM 21, a RAM 22, a wireless communication controller 23, a wired communication interface 24, a CPU 300 and a flash ROM 400. These components are interconnected by a bus.

The CPU 300 loads and executes a computer program stored in the ROM 21 on the RAM 22 to control the respective components of the access point 60. The CPU 300 also serves as an identification information acquirer 310, a settings information acquirer 320 and a generator 340. The identification information acquirer 310 and the settings information acquirer 320 are respectively equivalent to the identification information acquirer 110 and the settings information acquirer 120 of the first embodiment (FIG. 2). The generator 340 is described later.

The flash ROM 400 serving as the settings information storage unit stores identification information 410, set file information 420, settings information 430, file generation information 440 and AP settings information 450. The identification information 410, the set file information 420, the settings information 430 and the file generation information 440 are respectively equivalent to the identification information 210, the set file information 220, the settings information 230 and the file generation information 240 of the first embodiment. The file generation information 440 may be omitted as appropriate. The AP settings information 450 is used to store settings for network connection of the access point 60 (e.g., LAN settings or wireless LAN settings). The AP settings information 450 corresponds to the “storage unit” in the claims.

The wireless communication controller 23 includes an antenna (not shown) and a transmitting/receiving circuit. The wireless communication controller 23 serves for demodulation of signals received via the antenna and data generation from the demodulated signals, as well as for generation and modulation of signals to be sent via the antenna. The wired communication interface 24 serves as a connection port of a LAN cable for connecting with a local area network (LAN).

(B-2) Structures of Various Pieces of Information

The structures of various pieces of information according to the second embodiment are identical with those of the first embodiment shown in FIG. 3.

(B-3) Replication Process

(B-3-1) Configuration Search Process

The procedure of configuration search process according to the second embodiment is identical with that of the first embodiment shown in FIG. 5.

(B-3-2) Settings Information Acquisition Process

The procedure of settings information acquisition process according to the second embodiment is identical with that of the first embodiment shown in FIG. 7.

(B-3-3) Replicate Information Generation Process

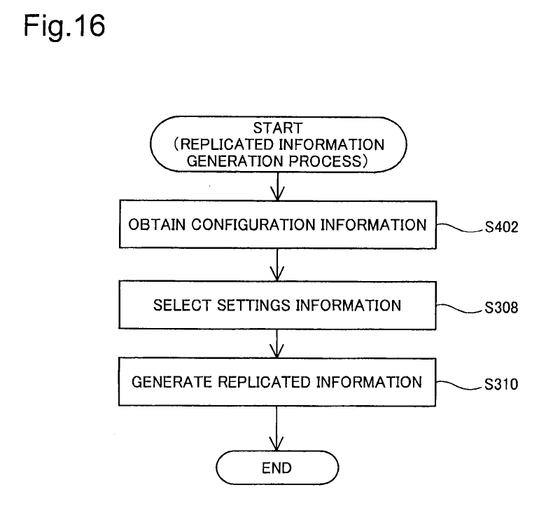

FIG. 16 is a flowchart showing the procedure of replicate information generation process according to the second embodiment. The differences from the first embodiment shown in FIG. 12 include replacement of step S302 with step S402 and omission of steps S304, S306 and S312.

The generator 340 of the access point 60 obtains the own configuration information (i.e., configuration information of the access point 60) (step S402). More specifically, the generator 340 refers to its own information stored at a preset location (for example, within the flash ROM 400) and obtains the class and the required item names of the self device. According to the second embodiment, the generator 340 serves as the configuration information acquirer. The file generation information 240 may be utilized for acquisition of the required item names in the same way as the first embodiment. The processing of steps S308 and S310 is similar to that of the first embodiment, except that the “wired connected device detected at step S306” in the first embodiment is replaced with the “self device” at step S310 without discrimination between the specified device and the non-specified device.

The second embodiment provides the network device having the similar advantageous effects to those of the first embodiment. In the configuration of the second embodiment without the information processing apparatus, the new network device (access point 60) autonomously replicates the settings information of the old network device (first network device N1) into the new network device itself. This improves the convenience.

According to the second embodiment, the new network device (access point 60) has the similar configuration to that of the information processing apparatus of the first embodiment, so as to autonomously replicate the settings information of the old network device (first network device N1) into the new network device itself. According to another embodiment, the old network device (first network device N1) may have the similar configuration to that of the information processing apparatus of the first embodiment, so as to automatically replicate the own settings information into the new network device (access point 60).

### C. Modifications

The foregoing has described the disclosure in detail with reference to the illustrative embodiments. The disclosure is, however, not limited to the above embodiments, but a multiplicity of variations and modifications may be made to the embodiments without departing from the scope of the disclosure. For example, the functions actualized by the software configuration may be implemented by the hardware configuration. Some examples of other possible modifications are given below.

C1. Modification 1:

The internal structures of the information processing apparatus and the network device are illustrated and described in the above embodiments. The structures according to the above embodiments are, however, only illustrative, and these devices may be configured according to various other aspects. For example, part of the components may be omitted, further components may be added, or part of the components may be changed.

For example, in the information processing apparatus of the first embodiment (FIG. 2), the identification information, the set file information, the settings information and the file generation information may be stored in an arbitrary storage medium other than the hard drive (e.g., DVD, compact flash (registered trademark)).

According to the second embodiment, the access point is employed as the network device that is capable of performing the replication process. According to other embodiments, any of various network devices other than the access point, such as a router or a switch may be employed instead.

In another example, the information processing apparatus of the first embodiment (FIG. 2) or the network device of the second embodiment (FIG. 15) may be configured to have another interface, such as a USB interface.

C2. Modification 2:

The internal structures of the first network device N1 and the second network device N2 are illustrated and described in the above embodiment. The structures according to the above embodiment are, however, only illustrative, and these devices may be configured according to various other aspects.

For example, each of the first network device N1 and the second network device N2 may include only one network device or may include a plurality of network devices. According to the disclosure, the information processing apparatus selects at least part of the settings information corresponding to the class of the second network device N2 among the settings information obtained from the first network device N1, and generates the replicate information from the selected settings information. Even when both the first network device N1 and the second network device N2 include only one network device, the information processing apparatus can generate the replicate information corresponding to the class of the second network device N2.

C3. Modification 3:

The procedure of configuration search process (FIG. 5) described in the above embodiment is only illustrative and may be modified and varied in various ways. For example, part of the steps may be omitted, further steps may be added, or the order of the steps may be changed.

For example, after step S116, the identification information acquirer may display a list of the devices found in the configuration search process on the display unit and may enable the user to add or change the data in the displayed list. This further improves the convenience.

C4. Modification 4:

The procedure of settings information acquisition process (FIG. 7) described in the above embodiment is only illustrative and may be modified and varied in various ways. For example, part of the steps may be omitted, further steps may be added, or the order of the steps may be changed.

For example, after acquisition of all the settings information (i.e., after step S224), the settings information acquirer may display a list of the updated settings information on the display unit and may enable the user to add or change the data in the displayed list. This further improves the convenience.

C5. Modification 5:

The procedure of the replicate information generation process (FIG. 12) described in the above embodiment is only illustrative and may be modified and varied in various ways. For example, part of the steps may be omitted, further steps may be added, or the order of the steps may be changed.

For example, instead of requesting the user to connect the information processing apparatus with a device included in the second network device N2 by wired (step S306), the information processing apparatus may utilize a preset value in a device included in the second network device N2 to access the device in the second network device N2.

In another example, when only the settings information obtained from the first network device N1 is insufficient as the information to be set in the second network device N2, the generator may generate the replicate information with parts corresponding to the missing settings information remaining vacant. The information to be set in the second network device N2 may be insufficient, for example, when the number of the settings information selected at step S308 is less than the number of settings information settable to the device connected by wired at step S306.

In another example, when only the settings information obtained from the first network device N1 is insufficient as the information to be set in the second network device N2, the generator may request the user to enter the missing settings information and generate the replicate information by additionally using the user's entries. In still another example, the generator may insert default settings into the missing settings information and generate the replicate information.

C6. Modification 6:

The tables (identification information, set file information, settings information and file generation information) included in the information processing apparatus are described in the above embodiment. The aspect of the embodiment is, however, only illustrative and may be modified or varied in various ways. For example, fields may be added, deleted or changed. In another example, the direct map system may be employed for the respective tables.

For example, the identification information may have a new filed for storing the host name. In another example, the identifier field may be omitted.

The items enumerated as the respective entries of the settings information shown in FIG. 11 are only illustrative. Another item (for example, prohibition or allowance for Any connection) may be included as an additional entry of the settings information shown in FIG. 11. Part of the entries of the settings information shown in FIG. 11 may be replaced with another item. For example, in the case of a router for domestic use, the “WAN settings” of the entry E06 may be replaced with another item including “provider destination IP address”, “user name” and “password”.

What is claimed is:

1. An apparatus configured to replicate a setting for network connection from a first network device to a second network device, comprising:
a settings information acquirer configured to obtain settings information on a network connection set in the first network device;
a settings information storage unit configured to store the settings information obtained by the settings information acquirer;
a configuration information acquirer configured to obtain configuration information including information representing a class of the second network device; and
a generator configured to select at least part of the settings information corresponding to the configuration information obtained by the configuration information acquirer from among the settings information stored in the settings information storage unit, and to use the at least part of the settings information to generate replicate information used to replicate the settings information to the second network device.

2. The apparatus according to claim 1, further comprising:
a replicator configured to access the second network device and update network connection settings in a storage unit of the second network device, with the generate replicate information.

3. The apparatus according to claim 1, wherein
the settings information acquirer obtains settings information on the network connection set in each of a plurality of first network devices.

4. The apparatus according to claim 1, wherein
the configuration information acquirer obtains configuration information including information representing class of each of a plurality of the second network devices, and
the generator selects at least part of settings information corresponding to the obtained configuration information with respect to each of the second network devices among the settings information stored in the settings information storage unit, and utilizes the at least part of the settings information to generate replicate information used to replicate the settings information to each of the second network devices.

5. The apparatus according to claim 1, further comprising:
an identification information acquirer configured to obtain identification information used to identify the first network device, wherein
the settings information acquirer obtains the settings information by utilizing the identification information obtained by the identification information acquirer.

6. The apparatus according to claim 5, wherein
the identification information acquirer sends a preset packet by multicast or by broadcast and obtains the identification information from a reply packet sent in reply to the preset packet.

7. The apparatus according to claim 5, wherein
the identification information acquirer employs UPnP (Universal Plug and Play) to obtain the identification information.

8. The apparatus according to claim 5, wherein
the identification information acquirer issues a check command to verify network communication to all IP addresses estimated to exist in an identical segment, in which the apparatus belongs to, and obtains the identification information from a reply to the check command.

9. The apparatus according to claim 1, wherein
the settings information acquirer obtains information in a storage unit of the first network device and analyzes the obtained information, so as to obtain the settings information.

10. The apparatus according to claim 1, wherein
the settings information storage unit further stores item information correlated to the settings information, wherein the item information is used to identify each item of the settings information, and
the settings information acquirer obtains information used for a service provided by the first network device to enable the setting for network connection, and retrieves the item information from the information obtained by the settings information acquirer, so as to obtain the settings information.

11. The apparatus according to claim 1, wherein
the configuration information acquirer obtains the configuration information based on user-entered information on a preset entry window.

12. The apparatus according to claim 1,
the apparatus being one of the first network device, the second network device, another network device and an information processing apparatus.

13. A method of replicating a setting for network connection from a first network device to a second network device, comprising:
obtaining settings information on a network connection set in the first network device;
storing the obtained settings information;
obtaining configuration information including information representing class of the second network device; and
selecting with a processing circuit at least part of the settings information corresponding to the configuration information obtained from among the stored settings information, and utilizing the at least part of the settings information to generate replicate information used to replicate the settings information to the second network device.

14. The method according to claim 13, further comprising:
accessing the second network device and updating network connection settings in a storage unit of the second network device, with the generated replicate information.

15. The method according to claim 13, wherein
said obtaining settings information obtains settings information on the network connection set in each of a plurality of first network devices.

16. The method according to claim 13, wherein
said obtaining configuration information includes obtaining configuration information including information representing class of each of a plurality of the second network devices, and
said generating replicate information includes selecting at least part of settings information corresponding to the obtained configuration information with respect to each of the second network devices among the settings information stored in the settings information storage unit, and utilizes the at least part of the settings information to generate replicate information used to replicate the settings information to each of the second network devices.

17. The method according to claim 13, further comprising:
obtaining identification information used to identify the first network device, wherein
said obtaining settings information obtains the settings information by utilizing the identification information.

18. The method according to claim 17, wherein
said obtaining identification information includes sending a preset packet by multicast or by broadcast and obtains the identification information from a reply packet sent in reply to the preset packet.

19. The method according to claim 17, wherein
said obtaining identification information employs UPnP (Universal Plug and Play) to obtain the identification information.

20. The method according to claim 17, wherein
said obtaining identification information including issuing a check command to verify network communication to all IP addresses estimated to exist in an identical segment, in which the apparatus belongs to, and obtaining the identification information from a reply to the check command.

21. The method according to claim 13, wherein
said obtaining settings information obtains information in a storage unit of the first network device and analyzes the obtained information, so as to obtain the settings information.

22. The method according to claim 13, wherein
said storing settings information further stores item information correlated to the settings information, wherein the item information is used to identify each item of the settings information, and
said obtaining settings information includes information obtained and used for a service provided by the first network device to enable the setting for network connection, and retrieves the item information from the information obtained, so as to obtain the settings information.

23. The method according to claim 13, wherein
said obtaining configuration information obtains the configuration information, based on information entered on a preset entry window.

24. A non-transitory computer readable storage device having instructions stored thereon that when executed by a processing circuit implement a method of replicating a setting for network connection from a first network device to a second network device, the method comprising:
obtaining settings information on a network connection set in the first network device;
storing the obtained settings information;
obtaining configuration information including information representing class of the second network device; and
selecting with a processing circuit at least part of the settings information corresponding to the configuration information obtained from among the stored settings information, and utilizing the at least part of the settings information to generate replicate information used to replicate the settings information to the second network device.
